(19) United States
(12) Patent Application Publication
(10) Pub. No.: US 2008/0017253 A1
(43) Pub. Date: Jan. 24, 2008

(54) Gas Regulator

(76) Inventor: Ui-Chang Kang, Shihung-City (KR)

Correspondence Address: IPLA P.A., 3580 WILSHIRE BLVD., 17TH FLOOR, LOS ANGELES, CA, 90010, US

(21) Appl. No.: 11/571,419

(22) PCT Filed: Jul. 23, 2005
(86) PCT No.: PCT/KR05/02390

§ 371 Date: Dec. 28, 2006

(30) Foreign Application Priority Data
Jul. 23, 2004 (KR) 10-2004-0057435

(51) Int. Cl. F17C 13/04; F16K 17/34; G05D 7/00

(52) U.S. Cl. 137/484.2

(57) ABSTRACT

The present invention relates to a gas regulator which can limit the pressure of gas flowing into the gas regulator, thus allowing the gas regulator to be operated safely. When gas having pressure higher than a preset reference pressure flows into the gas regulator, an auxiliary cylinder unit is automatically closed by a preset reference pressure, thus preventing damage to the gas regulator caused by the carelessness of a user. The gas regulator uses a piston instead of a conventional diaphragm, thus being semi-permanently usable and almost completely preventing leakage of gas from the gas regulator. The springs of the auxiliary cylinder chamber and the main cylinder chamber have different elasticities, thus letting different forces be applied to the auxiliary piston and the main piston in response to the inflow of high pressure gas, so that the auxiliary piston and the main piston may be operated together or independently.

### TECHNICAL FIELD

The present invention relates to gas regulators, which can keep pressures of a variety of gases, such as oxygen gas, at predetermined constant pressures regardless of variation in output loads when using the gases, contained in respective pressure gas tanks in highly compressed states, and to a gas regulator which can limit the pressure of gas flowing into the gas regulator, thus allowing the gas regulator to be operated safely.

### BACKGROUND ART

Described in detail, a conventional gas regulator comprises a body having a coupling unit to detachably couple the body to a pressure gas tank, a high pressure gauge to measure gas pressure of the pressure gas tank, and a disc unit. A cylinder chamber is defined in the lower part of the body. When a main piston having an auxiliary piston is installed in the cylinder chamber, a piston ring is installed in an intermediate step part of the cylinder of the body while a rod, which is provided in the disc unit, is brought into contact with the head of the auxiliary piston. Furthermore, a cap, which has a compression spring and a cap-shaped hollow circular pad that is holed through its central axis, is assembled with the body. Thus, the interior of the body and the interior of the cap define a cylindrical bore, wherein the main piston is moved. A threaded hole is formed through the center of the lower end of the cap. A hollow bolt, having an axial hole formed through the central axis of the bolt, is fastened to the threaded hole. A pressure regulating handle is mounted to the end of the hollow bolt so that a user can easily manipulate the gas regulator. Furthermore, to allow the user to regulate the outlet pressure of the gas while checking the outlet pressure, a low pressure gauge and a low pressure gas outlet nipple are provided on the gas regulator.

However, the conventional gas regulator, which has been typically used in the related art, has a safety valve so that, when excessively high pressure gas is mistakenly introduced into the gas regulator owing to the carelessness of a user, the safety valve is operated, and discharges the gas to the outside of the gas regulator.

Furthermore, the conventional gas regulator, which has been typically used in the related art, has used a diaphragm (made of thin canvas or synthetic resin), so that the expected life span of the gas regulator is reduced and the diaphragm may be easily damaged or broken to cause leakage of gas through the broken part of the diaphragm.

When the amount of gas in the pressure gas tank is reduced because the gas has been used for a long time, the pressure of gas is reduced. To increase the gas pressure of the tank, a user manipulates the pressure regulating handle, thus continuously using the gas in the tank. When the gas tank is emptied, the empty tank must be replaced with a new gas tank. In the above state, the new gas tank may be carelessly installed to replace the empty tank without returning the pressure regulating handle to its initial state. Thus, gas, which has pressure higher than a preset reference pressure, quickly flows into the gas regulator, so that the pressure of the gas regulator is excessively increased and breaks the gas regulator or a gas hose, and causes a severe accident.

### DISCLOSURE OF INVENTION

Technical Problem

Accordingly, the present invention has been made keeping in mind the above problems occurring in the prior art, and an object of the present invention is to provide a gas regulator, in which, when gas having pressure higher than a preset reference pressure flows into the gas regulator, an auxiliary cylinder unit is automatically closed by the preset reference pressure, thus preventing damage to the gas regulator caused by the carelessness of a user.

Another object of the present invention is to provide a gas regulator, which uses a piston instead of a conventional diaphragm, thus being usable semi-permanently and almost completely preventing leakage of gas from the gas regulator.

A further object of the present invention is to provide a gas regulator, which provides a difference between the elasticity of a spring of an auxiliary cylinder chamber and the elasticity of a spring of a main cylinder chamber, thus letting different forces be applied to an auxiliary piston and a main piston in response to the inflow of high pressure gas, so that the auxiliary piston and the main piston may be operated together or independently.

Yet another object of the present invention is to provide a gas regulator, in which the auxiliary piston unit is provided on the main piston unit, so that the pressure, applied from both a locking bolt and a spring of the auxiliary piston unit onto the auxiliary piston, can be regulated, and which thus more efficiently regulates the gas pressure.

Still another object of the present invention is to provide a gas regulator, in which the main cylinder chamber communicates with a safety valve, so that high pressure gas flowing into the main cylinder chamber can be discharged to the outside of the main cylinder chamber through the safety valve, thus more efficiently protecting the gas regulator.

Still another object of the present invention is to provide a gas regulator, in which a gas outlet nipple is mounted to a predetermined position of the body such that the nipple is inclined downwards at an angle, so that the nipple can be easily coupled to a gas hose without interference.

Technical Solution

In accordance with a first embodiment of the present invention, the gas regulator comprises a gas regulator, comprising a body having a predetermined size, a high pressure gas inlet chamber and a low pressure gas outlet hole formed at predetermined positions of the body to communicate with each other, a high pressure gauge secured to a predetermined position of the body around the high pressure gas inlet chamber, a low pressure gauge secured to a predetermined position of the body around the low pressure gas outlet hole, and a pressure regulating handle to regulate the amount of inlet gas which flows into the low pressure gas outlet hole and allow a user to confirm pressure of the inlet gas using both the high pressure gauge and the low pressure gauge and discharge gas to the outside if the pressure of the inlet gas flowing into a pre-determined portion of the body is higher than a preset reference pressure, further comprising:

a high pressure gas chamber being defined between the high pressure gauge and the high pressure gas inlet chamber and communicating with the high pressure gauge and the high pressure gas inlet chamber, thus guiding the inlet gas to the high pressure gauge, with a disc unit placed in the high pressure gas chamber such that the disc unit is movable upwards and downwards;

a main cylinder chamber being formed by depressing a predetermined position of a lower end of the body to a predetermined depth such that the main cylinder chamber communicates with the high pressure gas chamber, with a main piston unit comprising a main piston placed in the main cylinder chamber, and a cap having both a spring and a pad and being fastened to the body to support the main piston in the main cylinder chamber, the cap being opened at an end thereof to form an opening so that a pressure regulating bolt fastened to the pressure regulating handle is inserted into the opening and comes into contact with the pad, thus allowing the user to regulate the pressure of the inlet gas; and

an auxiliary cylinder chamber defined by vertically boring a predetermined portion of the main piston unit such that the auxiliary cylinder chamber communicates with a cylinder chamber gas inlet hole, with an auxiliary piston unit placed in the auxiliary cylinder chamber and operated in conjunction with the disc unit, thus regulating the pressure of the inlet gas, wherein a passage of the inlet gas flowing through the high pressure gas inlet chamber is closed or opened, thus preventing the gas regulator from being damaged by inlet gas having pressure higher than the preset reference pressure.

In accordance with a second embodiment of the present invention, the disc unit of the gas regulator comprises a sleeve, a disc, a rod, a spring, a flange and a packing and is placed in the high pressure gas chamber of the body, and is securely supported in a desired place by the high pressure gauge such that the disc unit moves upwards and downwards owing to the elasticity of the spring and wherein a lower end of the rod, which is inserted into a lower end of the disc, comes into contact with an end of the auxiliary piston unit, so that the cylinder chamber gas inlet hole is closed or opened according to the preset reference pressure of the auxiliary piston unit.

In accordance with a third embodiment of the present invention, the auxiliary piston unit of the gas regulator comprises an auxiliary piston, a shock absorbing pad, a piston ring, a spring and a locking bolt, wherein the auxiliary piston, the piston ring, the shock absorbing pad and the spring are sequentially inserted into the auxiliary cylinder chamber defined by vertically boring the main piston and, thereafter, the locking bolt is fastened to the main piston and biases the auxiliary piston using the spring, and is manipulated upwards and downwards to adjust the preset reference pressure, thus regulating the pressure of gas flowing into a low pressure gas inlet hole.

In accordance with a fourth embodiment of the present invention, the spring to bias the main piston upwards and the spring to bias the auxiliary piston upwards have different elasticities so that the main piston and the auxiliary piston are operated together or independently so as to regulate the pressure of the gas.

In accordance with a fifth embodiment of the present invention, the main piston and the auxiliary piston of the gas regulator have respective upper surfaces having different surface areas, thus causing different forces to be applied to the respective upper surfaces of the pistons, so that the main piston and the auxiliary piston are moved downwards together or independently and thus regulate the pressure of the gas.

Advantageous Effects

The present invention having the above-mentioned construction provides the following advantageous effects.

The present invention is advantageous in that, when gas having pressure higher than a preset reference pressure flows into a gas regulator, an auxiliary cylinder unit is automatically closed by the preset reference pressure, thus preventing damage to the gas regulator caused by the carelessness of a user.

The present invention is also advantageous in that the gas regulator uses a piston instead of a conventional diaphragm, thus being usable semi-permanently and almost completely preventing leakage of gas from the gas regulator.

The present invention is further advantageous in that the gas regulator provides a difference between the elasticity of a spring of an auxiliary cylinder chamber and the elasticity of a spring of a main cylinder chamber, thus letting different forces be applied to an auxiliary piston and a main piston in response to the inflow of high pressure gas into the gas regulator, so that the auxiliary piston and the main piston may be operated together or independently.

The present invention is further advantageous in that the auxiliary piston unit is provided on the main piston unit, so that the pressure, applied from both a locking bolt and a spring of the auxiliary piston unit onto the auxiliary piston, can be regulated, and the gas regulator can more efficiently regulate the gas pressure.

The present invention is further advantageous in that the main cylinder chamber communicates with a safety valve, so that high pressure gas flowing into the main cylinder chamber can be discharged to the outside of the main cylinder chamber through the safety valve, thus more efficiently protecting the gas regulator. The present invention is further advantageous in that a gas outlet nipple is mounted to a pre-determined position of the body such that the nipple is inclined downwards at an angle, so that the nipple can be easily coupled to a gas hose without interference.

### BRIEF DESCRIPTION OF THE DRAWINGS

FIG. 1 is a front sectional view illustrating an embodiment of a gas regulator according to the present invention;

FIG. 2 is a side sectional view illustrating the embodiment of the gas regulator according to the present invention;

FIG. 3 is a partially enlarged sectional view illustrating the operation of a disc unit of the gas regulator shown in FIG. 1; and

FIG. 4 is an enlarged sectional view illustrating the portion B of the gas regulator shown in FIG. 3.

### BEST MODE FOR CARRYING OUT THE INVENTION

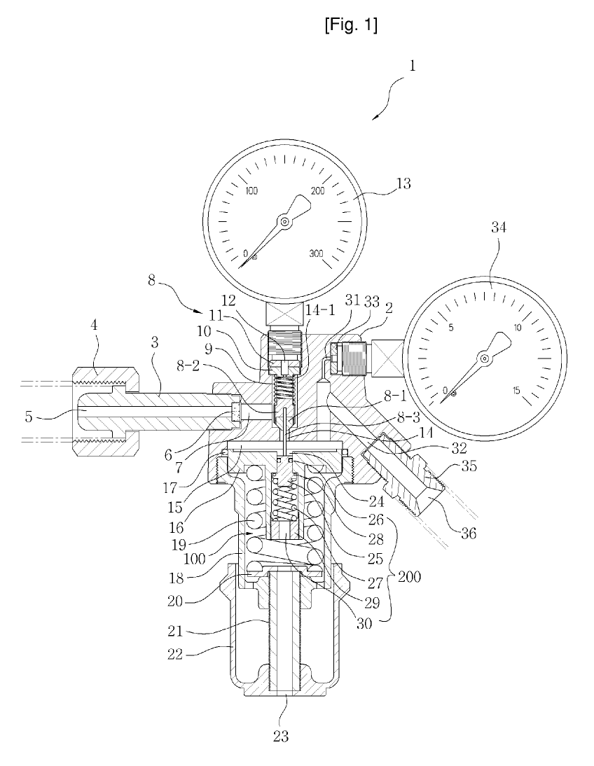

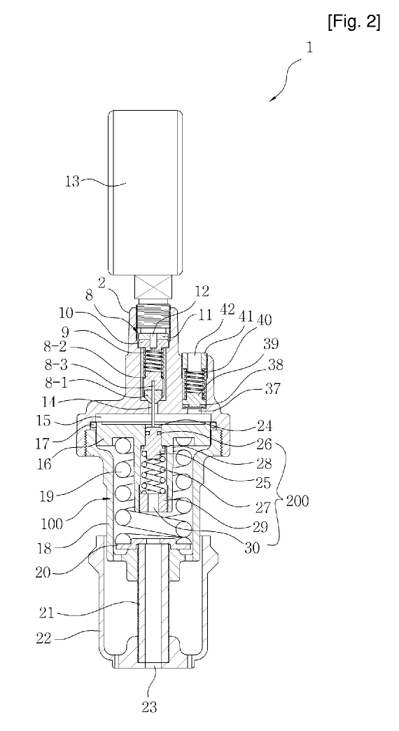

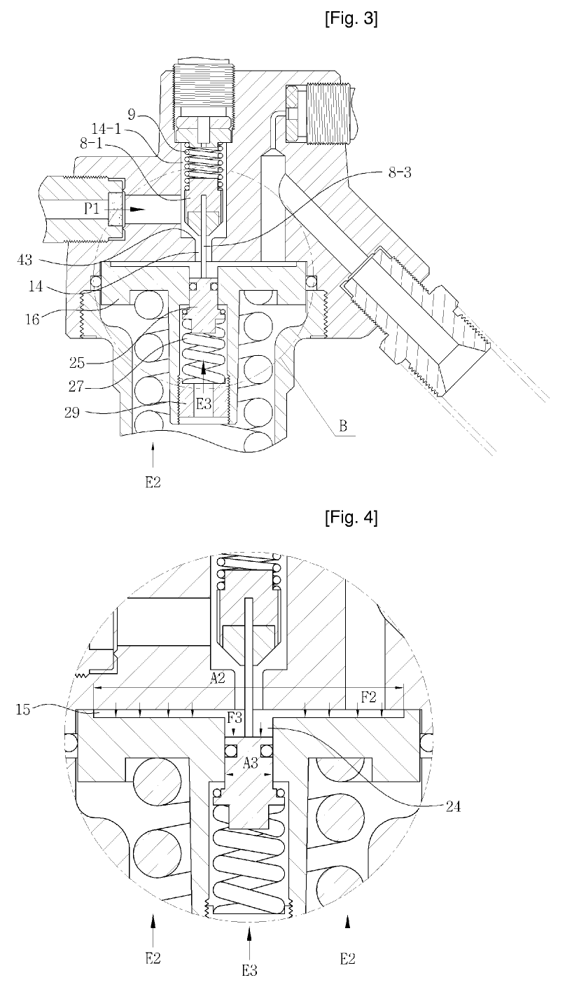

FIG. 1 is a front sectional view illustrating an embodiment of a gas regulator according to the present invention. FIG. 2 is a side sectional view illustrating the embodiment of the gas regulator according to the present invention. FIG. 3 is a partially enlarged sectional view illustrating the operation of a disc unit of the gas regulator shown in FIG. 1. FIG. 4 is an enlarged sectional view illustrating the portion B of the gas regulator shown in FIG. 3.

As shown in FIGS. 1 and 2, the gas regulator 1 comprises a body 2, a coupling unit 3, a high pressure gauge 13, a low pressure gauge 34, a disc unit 8 and a piston unit 100.

The body 2, which has a predetermined size, comprises a high pressure gas inlet chamber 7, a cylinder chamber gas inlet hole 14, a high pressure gas chamber 14-1, a low pressure gauge gas inlet hole 31 and a low pressure gas inlet hole 32 which have predetermined sizes and are formed in the body 1 and communicate with each other. Thus, when high pressure gas flows into the body 2, the body 2 can measure the pressure of the gas and cause the gas to be discharged at a preset reference pressure through the low pressure gas inlet hole 32.

The coupling unit 3 comprises a coupling nut 4 and a filter 6. The filter 6 is inserted into a high pressure gas inlet chamber 7 formed at a predetermined position of the body 2 and, thereafter, the coupling unit 3 is fastened at an end thereof to the body 2. The coupling nut 4 is fastened to the other end of the coupling unit 3, so that the gas regulator 1 can be coupled to a high pressure gas tank.

The high pressure gauge 13 is a conventional gauge, which can display the pressure of high pressure gas, and is fastened through a screw type engagement to the high pressure gas chamber 14-1 formed at a predetermined position of the body 2. Thus, the gauge 13 can display the pressure of the high pressure gas, which is introduced into the high pressure gas chamber 14-1, and allows a user to frequently compare the pressure of the gas to a preset reference pressure.

The low pressure gauge 34 is a conventional gauge, which can display the pressure of low pressure gas, which is introduced into the low pressure part of the gas regulator. When the pressure of the high pressure gas has been checked, the gauge 34 compares the gas pressure to the preset reference pressure of the auxiliary piston unit 200, and checks whether the gas pressure is a usable pressure or not.

The disc unit 8 comprises a disc 8-1, a sleeve 8-2, a rod 8-3, a spring 9, a flange 10 and a packing 11. The disc unit 8 is inserted into the high pressure gas chamber 14-1 and is locked to the body 2 by tightening the high pressure gauge 13 to the body 2. The high pressure gas chamber 14-1, which has a predetermined size, is formed in the upper end of the body 2 and communicates with predetermined portions of both the cylinder chamber gas inlet hole 14 and the high pressure inlet chamber 7. Thus, when high pressure gas is introduced into the body 2, the disc unit 8 communicates with the high pressure gauge 13, so that the high pressure gas can flow into the high pressure gauge 13 and communicate with the auxiliary piston 25.

The disc 8-1 is a cylindrical disc having a predetermined size, with a predetermined inclined surface formed on an end of the disc, so that the disc can be brought into close contact with a surface of the cylinder chamber gas inlet hole 14. The disc 8-1 is holed through the central axis of the inclined surface, thus having a through hole of a pre-determined size. Thus, the rod 8-3 is inserted into the through hole of the disc 8-1, such that the rod 8-3 can be operated in conjunction with the auxiliary piston 25.

The sleeve 8-2 has a size equal to the size of the disc 8-1 and is assembled with the disc 8-1. The sleeve 8-2 is holed along the central axis thereof such that the hole of the sleeve 8-2 corresponds to the through hole of the disc 8-1. The rod 8-3 can be inserted into and securely supported in the through hole of the sleeve 8-2.

The rod 8-3 has a cylindrical rod shape having a predetermined size and is coupled to both the disc 8-1 and the sleeve 8-2, and comes into contact with the upper surface of the auxiliary piston 25, so that the rod 8-3 can be operated in conjunction with the piston 25.

The spring 9 is coupled at a first end thereof to an end surface of the sleeve 8-2, is brought into close contact at a second end thereof with the packing of the flange 10, and is secured in place by tightening the high pressure gauge 13 to the body 2. Thus, the spring 9 can be compressed and expanded, thus allowing the disc 8-1 to open or close the seat surface 43 of the cylinder chamber gas inlet hole 14.

The flange 10 has a circular plate shape having a predetermined size and supports the first end of the spring 9. A high pressure gauge gas inlet hole 12 is formed through the center of the flange 10, thus allowing high pressure gas to be introduced into the high pressure gauge 13.

The packing 11 has a size equal to the size of the flange 10 and is holed to communicate with the high pressure gauge gas inlet hole 12 of the flange 10. The packing 11 is in contact with a surface of the flange 10 so that, when the disc unit 8 is securely placed in the high pressure gas chamber 14-1 of the body 2 by tightening the high pressure gauge 13 to the body 2, the packing 11 functions to absorb shocks and protects the disc unit 8 from damage.

The piston unit 100 comprises a main piston unit and an auxiliary piston unit.

The main piston unit comprises a main piston 16, a piston ring 17, a cap 18, a spring 19, a pad 20, a pressure regulating bolt 21, and a pressure regulating handle 22.

The main piston 16 has a size which corresponds to the predetermined size of a main cylinder chamber 15 formed in the lower part of the body 2, with the auxiliary piston unit 200, having a predetermined size, axially protruding from the center of the main piston 16.

The piston ring 17 is fitted over a predetermined position of the outer circumferential surface of the main piston 16, and comes into close contact with the inner surface of the main cylinder chamber 15 of the body 2, so that, when the main piston 16 moves upwards and downwards in the main cylinder chamber due to high pressure gas, the piston ring 17 prevents the gas from leaking to the outside of the body 2.

The cap 18 is a hollow body having a predetermined size, with the pad 20 inserted into the cap 18, so that the spring 19 can be brought into close contact with the pad 20 and the end of the main piston 16 at both ends thereof, thus biasing the main piston 16 upwards. Correspondingly, part of the outer circumferential surface of the cap 18 is assembled with the inner circumferential surface of the main cylinder chamber 15 of the body 2 through a screw type engagement.

Furthermore, the cap 18 is opened at an end thereof in which the pad 20 is placed.

The pressure regulating bolt 21, which has a predetermined size and is hollowed, is installed in the opening of the cap 18 through a screw type engagement. The pressure regulating handle 22 is mounted to the other end of the pressure regulating bolt 21. Thus, when a user moves the pressure regulating bolt 21 upwards or downwards by manipulating the pressure regulating handle 22, the main piston 16 is moved in the same direction by means of both the pad 20 and the spring 19 which are operated in conjunction with the pressure regulating bolt 21. Therefore, the pressure of high pressure gas which has been introduced into the body 2 can be regulated, so that the pressure of the inlet gas which enters through the low pressure gas inlet hole 32 can be regulated.

Furthermore, a wrench insertion hole 23 is formed through the center of the lower end of the pressure regulating handle 22, which is locked to the pressure regulating bolt 21, such that the wrench insertion hole 23 communicates with the main cylinder chamber 15.

The auxiliary piston unit 200 is formed by protruding a predetermined part of the piston unit 100, and comprises an auxiliary cylinder chamber 24, the auxiliary piston 25, a piston ring 26, a spring 27, a shock absorbing pad 28 and a locking bolt 29.

The auxiliary cylinder chamber 24 is formed through the center of the main piston 16 such that one end of the chamber 24 communicates with the main cylinder chamber 15 and the other end of the chamber 24 communicates with the wrench insertion hole 23. The end of the chamber 24, which communicates with the main cylinder chamber 15, is closed by the auxiliary piston 25, while the locking bolt 29 is inserted into the other end of the chamber 24 which communicates with the wrench insertion hole 23. The spring 27 is placed between the locking bolt 29 and the auxiliary piston 25 such that the spring 27 can move upwards and downwards to regulate the gas pressure.

The auxiliary piston 25 is placed in the auxiliary cylinder chamber 24, with a groove having a predetermined size formed around the outer circumferential surface of the auxiliary piston 25. The piston ring 26 is fitted into the groove of the auxiliary piston 25 so that the outer circumferential surface of the piston 25 comes into close contact with the inner circumferential surface of the chamber 24 through the piston ring 26, thus preventing high pressure gas from leaking to the outside of the chamber 24.

The locking bolt 29 has a predetermined size, with a wrench seating hole 30 formed in the bolt 29. As described above, the locking bolt 29 is fastened through a screw type engagement to the inner surface of the end of the auxiliary cylinder chamber 24 which is opposed to the auxiliary piston 25. The locking bolt 29 supports both the spring 27 and the auxiliary piston 25 and communicates with the wrench insertion hole 23, so that the locking bolt 29 can be moved upwards and downwards using a wrench, thus regulating the gas pressure.

The operation of the present invention will be described herein below with reference to the above-mentioned embodiment.

As shown in FIGS. 3 and 4, to use regulated gas, a user connects the coupling nut of the gas regulator of the present invention to a pressure gas tank which contains high pressure gas therein. Thereafter, one end of a gas hose is connected to an outlet unit 35 of the regulator 1, while the other end of the hose is connected to a desired device, such as a machine or an implement requiring gas. After the connection of the hose, the pressure regulating handle 22 is rotated counterclockwise, thus moving the main piston 16 downwards until the disc 8-1 of the disc unit 8 comes into close contact with the seat surface 43 and the cylinder chamber gas inlet hole 14 is closed. Thereafter, a control valve of the pressure gas tank is slowly rotated counterclockwise, thus opening the gas tank. In the above state, the user confirms the position of the hand on the graduations of the high pressure gauge 13 and rotates the pressure regulating handle 22 clockwise to move the main piston 16 upwards, thus separating the disc 8-1 from the seat surface 43 and opening the cylinder chamber gas inlet hole 14. When the gas flows into the gas regulator, the user regulates the gas pressure while viewing the graduations of the low pressure gauge 34 and uses the regulated gas. If the pressure of the gas is reduced because of the gas consumption, the user checks the graduation of the high pressure gauge 13 and rotates the pressure regulating handle 22 clockwise at the time when the pressure is reduced below a preset level (possible to check the pressure from the graduation of the low pressure gauge). Thus, the cylinder chamber gas inlet hole 14 is further opened, so that the user can use the gas remaining in the gas tank. When the pressure gas tank is emptied, the empty gas tank is replaced with a new gas tank to realize continuous use.

If a user opens the control valve of the pressure gas tank under the condition that the cylinder chamber gas inlet hole 14 of a conventional gas regulator has been carelessly left open, as do many users, high pressure gas is quickly introduced into the gas regulator and may break the safety valve, the gas regulator or the gas hose, thus causing an accident.

However, when assuming that the pressure of carelessly introduced high pressure gas is P1, the surface area of the upper surface of the main piston 16 is A2, and the surface area of the upper surface of the auxiliary piston 25 is A3, the force F2 acting on the upper surface of the main piston 16 is calculated from A2*P1, and the force F3 acting on the upper surface of the auxiliary piston 25 is calculated from A3*P1. Furthermore, when assuming that the force applied from the spring 19 to the main piston 16 is E2 and the force applied from the spring 27 to the auxiliary piston 25 is E3, the main piston 16 is moved downwards if the force F2 is higher than or equal to the force E2. Furthermore, when the force F3 is higher than or equal to the force E3, the auxiliary piston 25 is moved downwards. In addition, because the surface area A3 of the upper surface of the auxiliary piston 25 is smaller than the surface area A2 of the upper surface of the main piston 16, the force F2 acting on the main piston 16 is always higher than the force F3 acting on the auxiliary piston 25.

Thus, when the force E2 is set to be higher than the force E3 and the force F3 is higher than the force E3, the auxiliary piston 25 can be moved downwards even if the force F2 is lower than the force E2. In the above state, the disc unit 8 is moved downwards and closes the cylinder chamber gas inlet hole 14, so that the quick inflow of the high pressure gas is stopped. Furthermore, when the force E2 is set to be lower than or equal to the force E3, the main piston 16 can be moved downwards prior to downward movement of the auxiliary piston 25 due to the force F2 which is always higher than the force F3. Thus, the cylinder chamber gas inlet hole 14 in the above state is closed and stops the quick inflow of the high pressure gas.

When the pressure regulating handle 22 is maintained at a clockwise rotated position after the use of the gas regulator of the present invention, so that the cylinder chamber gas inlet hole 14 is wide open (in other words, because E2 is set to be excessively high, E2 is higher than E3), high pressure gas may quickly flow into the gas regulator during a process of replacing an empty pressure gas tank with a new pressure gas tank and may cause an accident. The force E3 is preset by adjusting the elasticity of the spring 27 by rotating the locking bolt 29 using a wrench which is inserted into the wrench insertion hole 23, so that, if the elasticity of the spring 27 is not changed again using the wrench, the force E3 can be maintained at the preset level, while the force E2 can be easily and frequently controlled by rotating the pressure regulating handle 22. Thus, it will be noted that, when the force E2 is set to be higher than the force E3 by manipulating the pressure regulating handle, the present invention will be beneficially adapted. Of course, because the main piston can be moved downwards in a case other than the above-mentioned case, the present invention may be easily adapted to the case without causing any problem.

Furthermore, when the high pressure gas is continuously used for a lengthy period of time and thereby the pressure of the high pressure gas is reduced, the main piston 16 is moved upwards and controls the opening ratio of the cylinder chamber gas inlet hole 14. In addition, the auxiliary piston 25 can be moved upwards owing to the compression force of the spring 27 of the auxiliary piston unit 200 and, at the same time, the disc 8-1 is operated concurrently and controls the opening ratio of the cylinder chamber gas inlet hole 14. Thus, the amount of gas to flow into the low pressure gas inlet hole 32 can be increased so that a user can use the low pressure gas which flows into the regulator through the low pressure gas inlet hole 32.

Although the preferred embodiment of the present invention has been disclosed for illustrative purposes, those skilled in the art will appreciate that various modifications, additions and substitutions are possible without departing from the scope and spirit of the invention as disclosed in the accompanying claims.

1. A gas regulator, comprising a body having a predetermined size, a high pressure gas inlet chamber and a low pressure gas outlet hole formed at predetermined positions of the body to communicate with each other, a high pressure gauge secured to a predetermined position of the body around the high pressure gas inlet chamber, a low pressure gauge secured to a predetermined position of the body around the low pressure gas outlet hole, and a pressure regulating handle to regulate the amount of inlet gas which flows into the low pressure gas outlet hole and allow a user to confirm pressure of the inlet gas using both the high pressure gauge and the low pressure gauge and discharge gas to the outside if the pressure of the inlet gas flowing into a predetermined portion of the body is higher than a preset reference pressure, further comprising:
a high pressure gas chamber being defined between the high pressure gauge and the high pressure gas inlet chamber and communicating with the high pressure gauge and the high pressure gas inlet chamber, thus guiding the inlet gas to the high pressure gauge, with a disc unit placed in the high pressure gas chamber such that the disc unit is movable upwards and downwards;
a main cylinder chamber being formed by depressing a predetermined position of a lower end of the body to a predetermined depth such that the main cylinder chamber communicates with the high pressure gas chamber, with a main piston unit comprising a main piston placed in the main cylinder chamber, and a cap having both a spring and a pad and being fastened to the body to support the main piston in the main cylinder chamber, the cap being opened at an end thereof to form an opening so that a pressure regulating bolt fastened to the pressure regulating handle is inserted into the opening and comes into contact with the pad, thus allowing the user to regulate the pressure of the inlet gas; and
an auxiliary cylinder chamber defined by vertically boring a predetermined portion of the main piston unit such that the auxiliary cylinder chamber communicates with a cylinder chamber gas inlet hole, with an auxiliary piston unit placed in the auxiliary cylinder chamber and operated in conjunction with the disc unit, thus regulating the pressure of the inlet gas, wherein a passage of the inlet gas flowing through the high pressure gas inlet chamber is closed or opened, thus preventing the gas regulator from being damaged by inlet gas having pressure higher than the preset reference pressure.

2. The gas regulator according to claim 1, wherein the disc unit comprises a sleeve, a disc, a rod, a spring, a flange and a packing and is placed in the high pressure gas chamber of the body, and is securely supported in a desired place by the high pressure gauge such that the disc unit moves upwards and downwards owing to the elasticity of the spring and wherein a lower end of the rod, which is inserted into a lower end of the disc, comes into contact with an end of the auxiliary piston unit, so that the cylinder chamber gas inlet hole is closed or opened according to the preset reference pressure of the auxiliary piston unit.

3. The gas regulator according to claim 2, wherein the auxiliary piston unit comprises an auxiliary piston, a shock absorbing pad, a piston ring, a spring and a locking bolt, wherein the auxiliary piston, the piston ring, the shock absorbing pad and the spring are sequentially inserted into the auxiliary cylinder chamber defined by vertically boring the main piston and, thereafter, the locking bolt is fastened to the main piston and biases the auxiliary piston using the spring, and is manipulated upwards and downwards to adjust the preset reference pressure, thus regulating the pressure of gas flowing into a low pressure gas inlet hole.

4. The gas regulator according to claim 3, wherein the spring to bias the main piston upwards and the spring to bias the auxiliary piston upwards have different elasticities so that the main piston and the auxiliary piston are operated together or independently so as to regulate the pressure of the gas.

5. The gas regulator according to claim 4, wherein the main piston and the auxiliary piston have respective upper surfaces having different surface areas, thus causing different forces to be applied to the respective upper surfaces of the pistons, so that the main piston and the auxiliary piston are moved downwards together or independently and thus regulate the pressure of the gas.
